(19) United States
(12) Patent Application Publication
(10) Pub. No.: US 2015/0313343 A1
(43) Pub. Date: Nov. 5, 2015

(54) Multicolor eyeliner, lipliner, balpoint pen

(71) Applicant: Bela William Weibl, SR., Las Vegas, NV (US)

(72) Inventor: Bela William Weibl, SR., Las Vegas, NV (US)

(21) Appl. No.: 13/998,764

(22) Filed: May 5, 2014

(51) Int. Cl. A45D 34/04; B43K 27/08

(52) U.S. Cl. CPC A45D 34/04; B43K 27/08

(57) ABSTRACT

There are presently no suppliers in the cosmetics industry that offer an eyeliner applicator with more than two colors. My pen style applicator contains four different colors of eyeliner which can be selected by pressing down a button on top of the pen. The eyeliner is contained in replaceable cartridges which would be available in numerous colors. It is a simple 15 part device similar in design to an ordinary four color pen. It consists of three main body parts and twelve internal moving parts as shown in the drawings.

### CROSS REFERENCE TO RELATED APPLICATIONS

Not Applicable

### FEDERALLY SPONSORED RESEARCH

Not Applicable

### PARTIES TO JOINT RESEARCH AGREEMENT

Not Applicable

### REFERENCE TO SEQUENCE LISTING

Not Applicable

### BACKGROUND OF THE INVENTION

Following extensive research we were unable to find anyone who produces an applicator for cosmetic eyeliner containing more than two colors, the two color being one color on each end of the applicator pen. In spite of the demand for such a product, none so far exist.

### BRIEF SUMMARY

This eyeliner pen applicator is a simple 15 part device similar in design to the standard four color pen. It consists of three main body parts and twelve internal moving parts, and makes it possible for the user to carry four shades (colors) of eyeliner in a single pen sized applicator.

### BRIEF DESCRIPTION OF VIEWS

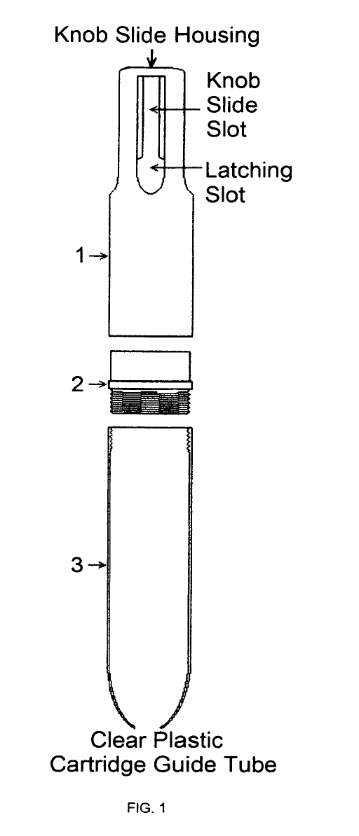

FIGS. 1 through 4 show the shape of the applicator and its various components in addition to illustrating how the mechanism operates.

### DETAILED DESCRIPTION

The main body parts are the plastic upper knob slide housing (1), the plastic center cartridge guide hub (2), and the clear plastic lower cartridge guide tube (3). See FIG. 1.

Within the main body assembly are four compartments which contain, and control the alignment of, the four cartridges (6) containing the manufactured eye shadow product.

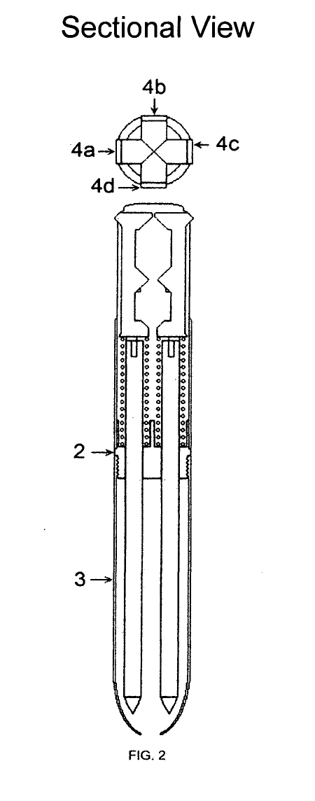

The internal moving parts are: four plastic push knob slides in separate colors (4a, 4b,4c, and 4d), four steel cartridge return springs (5a, 5b, 5c, and 5d), and four liquid or gel filled cartridges (6a, 6b, 6c, 6d) containing cosmetic eyeliner to be manufactured and made available in numerous colors. They are flexible tubes with individual ball roller, felt tip, or other, tip applicators. (6a-6d) The design may include more than four colors with minor modification in construction. See FIG. 2.

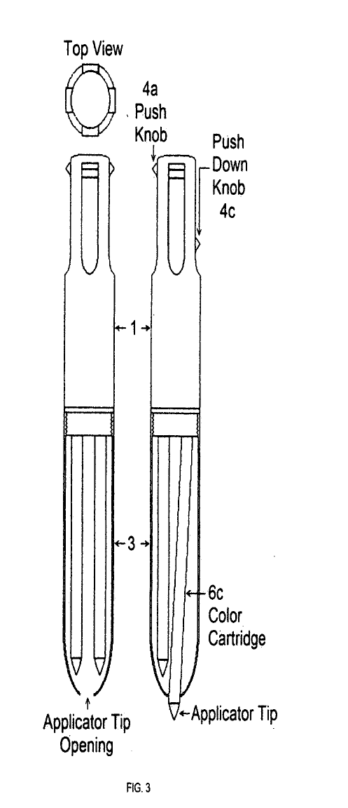

To apply the eyeliner the user will press down any one of the four colored push knobs (4). Each knob will push the corresponding colored eyeliner applicator tip down and out of the lower cartridge guide tube (3). See FIG. 3.

As any one of the four knobs (4a-d) is pushed down it will latch into its individual locking slot in the upper knob slide housing (1). This prevents the selected color cartridge applicator (4) from retracting back into the plastic guide tube (3) during application.

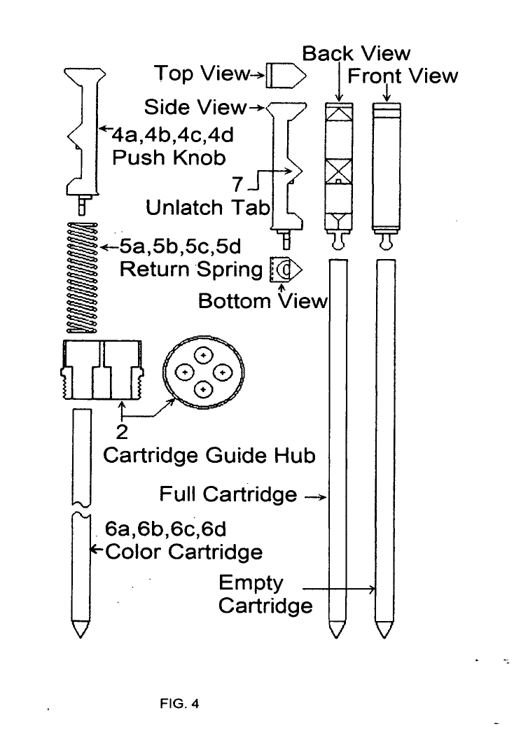

If another color eyeliner is to be selected for use, the corresponding knob (4) for that color is pushed down. The unlatch tab (7) on the knob (4) being depressed will push the existing one out of the latching slot, and the return spring (5) will return it up into the cartridge tube (3). This will allow the newly selected color push knob (4) to latch into place and be ready for use. See FIG. 4.

To get all applicator tips back into the cartridge tube after use, push any knob (4) down slightly and any exposed applicator tip will retract into the cartridge guide tube (3).

Cartridge replacement is accomplished by the following process: A. Unscrew the cartridge guide tube (3) off the center guide hub (2) B. Pull out the empty color cartridge (6a, 6b, 6c, or 6d) C. Push the new cartridge (6) into the cartridge tube (3) D. Screw the cartridge tube (3) and center hub (2) back together.

What is claimed is:

1. A composite liquid gel eyeliner applicator and holder with potential ability to contain other liquid gel cosmetic products, comprising of 2 hollow housing members (1,3), a cartridge guide hub (2), and a plurality of up to 4 carrier members (6a-d); the upper hollow housing member (1) comprising of 4 knob slide slots and latching slots used in conjunction with push knobs (4a-4d) and return springs (5a-5d) to protract/retract the carrier members (6a-6d) through the cartridge guide hub (2); the lower hollow housing member (3), has an applicator tip opening at one end where the carrier members (6a-6d) will protrude, and a plurality of up to 4 carrier members contained within; the cartridge guide hub (2) is in between the Upper housing member (1) and the lower housing member (3) containing 4 openings where the carrier members (6a-6d) will pass through; the carrier members (6a-6d) contain unique replaceable cosmetic cartridges with special ballpoint applicators, they will pass through the cartridge guide hub and attach to the bottom of the push knobs (4a-4d); Carrier members (6a-6d) replacement is achieved by unscrewing lower housing member (3) from Cartridge guide hub (2), pulling out the empty carrier member, and pushing the new carrier member through the cartridge guide hub until it attaches to the push knobs (4a-4d).
